(19) United States
(12) Patent Application Publication
(10) Pub. No.: US 2007/0045881 A1
(43) Pub. Date: Mar. 1, 2007

(54) Air humidifier

(76) Inventor: Everardo Lamberto Machuca Aguirre, Guadalajara (MX)

Correspondence Address: Karl M. Steins;Steins & Associates, Suite 120, 2333 Camino del Rio South, San Diego, CA, 92108, US

(21) Appl. No.: 11/219,081

(22) Filed: Sep. 1, 2005

(51) Int. Cl. B01F 3/04

(52) U.S. Cl. 261/142

(57) ABSTRACT

The air humidifier 2,976,026 needs to add water every half hour, while this new air humidifier only needs to add water every 24 hours, and this addition is made by hands (is made manually). In this new air humidifier the heater element is no longer in the tray elements but rather in the chamber C. The chamber C no longer consists of one cavity but of two cavities. One of these cavities is larger than the other and has water and the heater element inside it. The other cavity houses the blower.

### BACKGROUND OF THE INVENTION

This invention is an air humidifier that works better than the humidifier of U.S. Pat. No. 2,976,026.

This new humidifier is simpler, and has fewer elements: It does not have an F jar, or an G′ hook, or an E plug, or an N pipe, or an U exit, and the box C does not have feet.

### SUMMARY OF THE INVENTION

The air humidifier 2,976,026 needs to add water every half hour, while this new air humidifier only needs to add water every 24 hours, and this addition is made by hands (is made manually).

In this new air humidifier the heater element is no longer in the tray elements but rather in the chamber C.

The chamber C no longer consists of one cavity but of two cavities. One of these cavities is larger than the other and has water and the heater element inside it. The other cavity houses the blower.

The chamber C has a vertical wall inside (P) that goes from one side to the other and separates the t,o cavities. This wall is not as high as chamber C, leaving a long narrow gap in the upper part of chamber C where air passes from the smaller to the larger cavity.

This new air humidifier is composed of a plurality of identical elements so that it can be adapted to various degrees of humidification as required.

### BRIEF DESCRIPTION OF THE DRAWINGS

Other features of the present invention and many of the attendant advantages will become apparent from the following detailed description of an illustrated example of the invention when taken in conjunction with the accompanying drawings in which like reference i characters designate like parts through the figures thereof, and wherein:

FIG. 1 is a drawing of a conventional overview of the air humidifier;

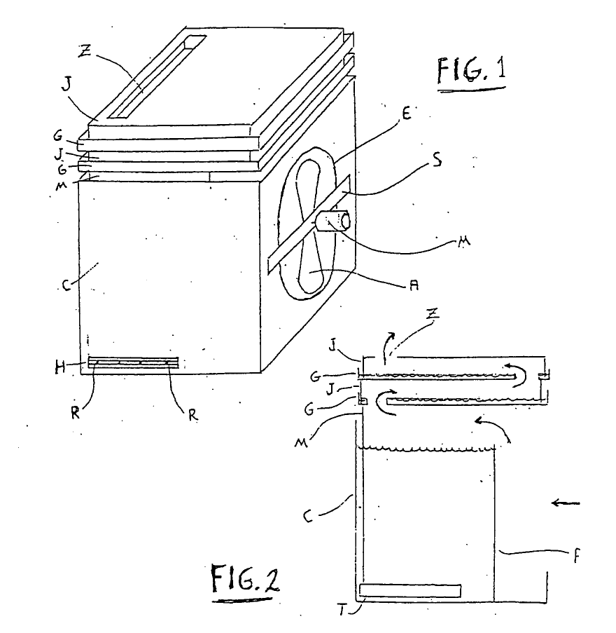

FIG. 2 is a lengthwise vertical cross section of the humidifier. This figure does not show the blower for sake of clarity. The arrows show the air path.

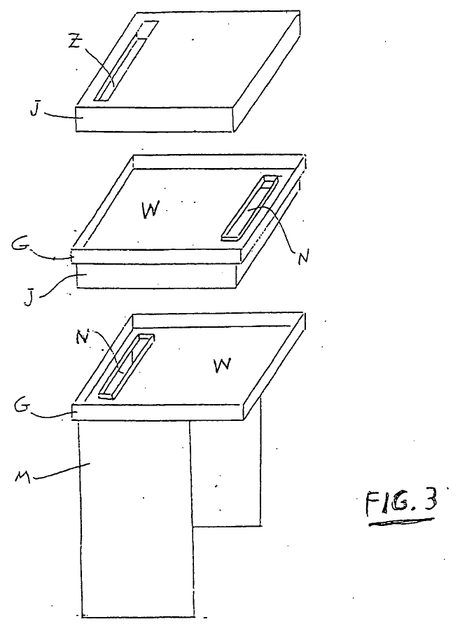

FIGS. 3, 4, and 5 are drawings of conventional overviews of the air humidifier itself, disassembled. Al the parts are separated.

The air chamber is represented as if it were made of transparent material to appreciate the inside clearly (except the T pipe and the P wall). The T pipe and the P wall are shown of material not transparent.

The lower tray element has a divider anchored in the larger cavity of chamber C, but it should be mentioned that there is not a divider at the site of wall P.

### DETAILED DESCRIPTION OF THE PREFERRED EMBODIMENTS

This new air humidifier is composed of a plurality of identical elements so that it can be adapted to various degrees of humidification as required.

The invention contemplates providing a plurality of superimposed tray elements, each having a bottom portion and a -all portion, the bottom portions and the wall portions of these superimposed tray elements defining a plurality of superimposed chambers. Water is supplied to the uppermost of the superimposed tray elements and the bottom portion of each tray element is equipped with an overflow that limits the height of water which is capable of being held in the tray element. The bottom portions of each tray element are formed with an opening for passage of air and water from one of the chambers to the adjacent one.

A blower is provided for forcing air into the lowermost tray element from which it passes gradually upward through the various elements in contact with the water flowing downward and finally escapes to the atmosphere in humidified condition from the uppermost chamber.

The lower tray element has a divider anchored in the larger cavity of chamber C, but it should be mentioned that there is not a divider at the site of wall P.

All the tray elements are formed in an identical manner each comprising a transverse bottom portion W from which a rim G extends peripherally upwardly whereas a wall portion J extends downward from a location on bottom portion W which is inward from rim G. The tray elements can thus be stacked in such a manner that wall portion J of a superimposed element stands on the bottom portion W of the subjacent element within the confines of rim G.

A chamber is thus enclosed between the bottom portion W and the wall portion J of the superimposed tray element which forms the upper and side walls of the chamber, and the bottom portion W of the subjacent tray element which forms the bottom of the chamber.

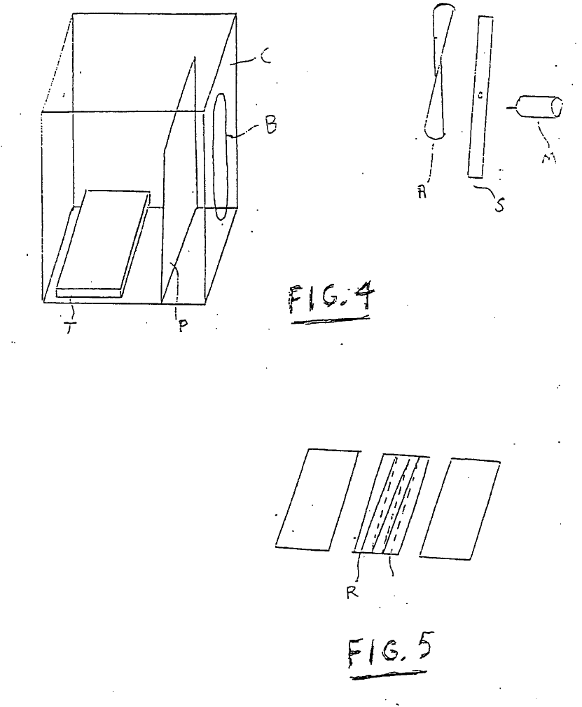

As best seen in FIG. 3, each individual tray element is formed with an elongated slot N near one edge of the bottom portion W. The slot N is surrounded by a raised edge lower than rim G. The uppermost tray element above which no chamber is formed may be made without a rim G and its elongated slot Z needs not be equipped with a raised edge although such an edge is not illustrated in the drawing, and serves as a reinforcing means only.

The example of an air humidifier of the invention illustrated in the drawing is assembled with two stacked tray elements but the number may be varied to suit prevailing conditions and the results to be achieved.

There is further provided a heating element H of a size suitable for insertion into the transverse duct T. The heating element H comprises two sheets of heat resistant insulating material and resistance electric wires mounted on a ceramic carrier, the carrier being sandwiched between the two sheets of heat resistant insulating material before insertion into the transverse duct T.

The afore-described apparatus operates as follow: The tray elements are assembled by superposition in such manner that the elongated slots N are arranged in parallel and horizontally offset with respect to each other in alternating positions so as to form a passage for air flowing through the humidifier which forces the air after rising upward into a chamber through one of the slots N to pass horizontally through practically the entire width of the chamber before passing upward into the next chamber through the elongated slot N in the next higher bottom portion W.

The tray elements are filled, manually, with water to the level of the rims surrounding the elongated slots N, any excess flowing downward into the subjacent tray element.

Air which is blown into the chamber C by fan A passes upward along the surface of the water in the lowermost tray and from there upward through the several tray elements countercurrent to the flow of the water, picking up moisture on the way, until it finally emerges humidified from the slot Z in the uppermost tray element.

Since the air is in its driest state when entering the lowermost tray element, the consumption of water in the lowermost element is greater than in any of the other tray elements.

The heat of evaporation of the water consumed in moistening the air is taken from the stream of air passing through the apparatus so that the air emerging from the opening Z of the humidifier is substantially cooler than that forced into the apparatus by fan A. This cooling effect may be desirable; if it is not, the water within the lowermost tray element may be heated by means of electric resistance heater element H to a temperature high enough to adjust the temperature of the discharged air in any desired manner.

Water is introduced by the uppermost chamber.

While the invention has been illustrated and described as embodied in an air humidifier it is not intended to be limited to the details shown since various modifications and structural changes may be made without departing in any way from the spirit of the present invention.

Without further analysis, the foregoing will so fully reveal the gist of the present invention that others can by applying current knowledge readily adapt it for various applications without omitting features that, from the standpoint of prior art, fairly constitute essential characteristics of the generic of specific aspects of this invention and, therefore, such adaptations should and are intended to be comprehended within the meaning and range of equivalence of the following claims.

What is claimed as new and desired to be secured by Letters Patent is:

1. An air humidifier characterized because its air chamber consists of two cavities.

2. An air humidifier as mentioned in clause 1 because one of its two cavities is larger than the other.

3. An air humidifier as mentioned in clause 2 because its large cavity has water and a heater element.

4. An air humidifier as mentioned in clause 3 because its small cavity has an air stream creating element.

5. An air humidifier as mentioned in clause 4 because the two cavities of its air chamber are separated by a vertical wall that encompasses the entire width of the air chamber but its height is less than that of the air chamber, leaving a transversal space in the upper part of the air chamber where the air can pass from the small cavity to the large cavity.
